(19) United States
(12) Patent Application Publication
(10) Pub. No.: US 2024/0295295 A1
(43) Pub. Date: Sep. 5, 2024

(54) ELECTRIC FENCING TAPE WITH INTEGRATED LED LIGHTS

(71) Applicant: Tricia DICKENS, Sandpoint, ID (US)

(72) Inventor: Tricia DICKENS, Sandpoint, ID (US)

(21) Appl. No.: 18/508,384

(22) Filed: Nov. 14, 2023

Related U.S. Application Data
(60) Provisional application No. 63/449,548, filed on Mar. 2, 2023.

(51) Int. Cl. F21S 4/10; A01K 3/00; E04H 17/00; E04H 17/04

(52) U.S. Cl. CPC F21S 4/10; A01K 3/005; E04H 17/017; E04H 17/05

(57) ABSTRACT

Electric fencing tape has LED lights embedded on the substrate material with the electric wires. The LED lights of the integrated electrical fencing tape can provide information regarding the status of the electric fence and be decorative as well.

### CROSS-REFERENCE TO RELATED APPLICATIONS

The present application claims priority to and the benefit of U.S. Provisional Patent Application No. 63/449,548, filed Mar. 3, 2023, the contents of which is hereby incorporated in its entirety.

### TECHNICAL FIELD

The present invention relates to electric fences and fencing tape for containing livestock and other animals and, in particular, to an electrical fencing tape system with integrated light emitting diode (LED) lighting for enhanced visibility, information providing, decorative purposes, and safety.

### BACKGROUND

An electric fence is a type of barrier that uses electric shocks to deter animals or people from crossing a boundary. It works by sending a high voltage pulse of electricity through a wire or tape that is attached to insulated posts. When an animal or person touches the wire, they receive a painful but harmless electric shock that quickly teaches them to avoid the fence. Electric fences are commonly used in agriculture and livestock management to keep animals contained and to protect crops from wildlife. They are also used in security systems to prevent unauthorized access to sensitive areas. Electric fences are also used to keep animals from entering a specific area, such as a residential garden.

Electric fences have several advantages over traditional physical fences. For one, they are relatively easy and inexpensive to install, and can be set up quickly without requiring a lot of digging or construction. They are also very effective at keeping animals in or out of an area, since the electric shock is a powerful deterrent that quickly trains animals to stay away from the fence. Additionally, electric fences are low-maintenance and can last for many years with minimal upkeep.

Despite their many benefits, electric fences can also pose some risks if not installed and maintained properly. The electric shocks they deliver can be dangerous or even fatal to humans or animals with certain medical conditions, and the fences can be damaged or short- circuited if not properly grounded or maintained. Electric fences can be difficult to see at night or in low-light conditions, which can pose a safety hazard for both animals and people.

Therefore, there is a need for an electric fence system with improved visibility and safety features.

### SUMMARY

Briefly described, aspects of the present disclosure relate to electrical fencing tape having LED lighting.

An aspect of the present disclosure is an electric fence system. The electric fence system comprising: at least one electrical wire adapted to transmit electricity; a plurality of LEDs adapted to light in a predetermined manner; and at least two fence posts, wherein the at least one electrical wire and the plurality of LEDs are adapted to be operably connected between the at least two fence posts.

Another aspect of the disclosure is an integrated electrical fencing tape. The

integrated electrical fencing tape comprising: a substrate material formed as an elongated rectangular section; a plurality of electrical wires located along a length of the substrate material; and a plurality of LEDs located on the substrate material along the length of the substrate material.

Still yet another aspect of the invention is a component for forming a fence. The component comprising: at least one electrical wire adapted to transmit electricity; a plurality of LEDs operably connected to a controller and adapted to light in a predetermined manner; and wherein the plurality of electrical wires are braided together with the plurality of LEDs.

### BRIEF DESCRIPTION OF THE DRAWINGS

FIG. 1 shows a diagram of electrical fencing tape with LED lights integrated.

FIG. 2 shows another diagram of electrical fencing tape with LED lights integrated.

FIG. 3 shows another diagram of electrical fencing tape with LED lights integrated.

FIG. 4 shows another diagram of electrical fencing tape with LED lights integrated using braiding.

FIG. 5 shows a diagram of an electric fence system that implements the integrated electrical fencing tape.

### DETAILED DESCRIPTION OF ILLUSTRATIVE EMBODIMENTS

To facilitate an understanding of embodiments, principles, and features of the present disclosure, they are disclosed hereinafter with reference to implementation in illustrative embodiments. Embodiments of the present disclosure, however, are not limited to use in the described treatments or methods and may be utilized in other treatments and methods as will be understood by those skilled in the art familiar with this disclosure.

The components described hereinafter as making up the various embodiments are intended to be illustrative and not restrictive. Many suitable components that would perform the same or a similar function as the components described herein are intended to be embraced within the scope of embodiments of the present disclosure.

Electrical fencing tape, also known as electric fence ribbon, is a type of fencing material that is used to contain animals or livestock within a designated area as well as preventing animals from entering a particular area. It is typically made of durable and flexible plastic or vinyl material that is designed to withstand the outdoor environment.

Electrical fencing tape has thin metal wires embedded within the material. These thin metal wires carry an electrical charge when connected to a source of power. When an animal contacts the tape, it completes the electrical circuit, delivering a harmless but startling shock that encourages the animal to stay within the designated area.

Electrical fencing tape is available in various widths and lengths and can be installed using fencing equipment. It is used in agricultural and rural settings to keep livestock contained but can also be used for other applications such as protecting gardens or keeping pets within a specific area. Electrical fencing tape is generally considered to be an effective and humane way to contain animals, as it delivers a mild and temporary shock that discourages them from attempting to breach the fence.

The present invention provides an electric fence system that utilizes electrical fencing tape with integrated LED lighting that enhances visibility and safety. The system additionally enables the LED lighting to provide status updates regarding the electric fence system and the lights.

The electric fence system with integrated LED lighting comprises a series of posts, electrical fencing tape, and insulators. These components are assembled to create a barrier. In addition, LED lights are interwoven or otherwise embedded, with the electrical fencing tape.

In an embodiment, the LED lights are operably connected to the same power source as the electrical fencing tape, which may be, for example, a battery or an AC power supply. In an embodiment, the AC power supply is separate from the AC power supply for the electrical fencing tape. In an embodiment, the AC power supply is provided in addition to the electrical power supply for the electrical fencing tape.

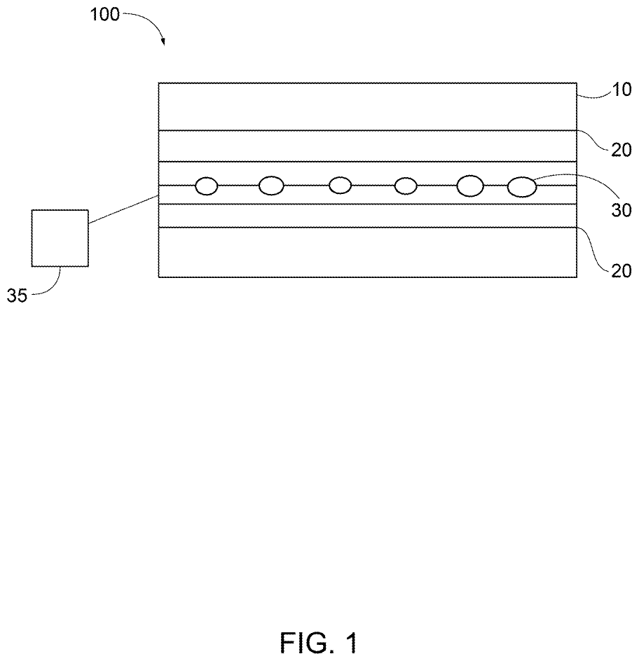

Turning to the figures, wherein like numerals refer to similar components throughout the drawings and specification. Shown in FIG. 1 is a diagram of a section of integrated electrical fencing tape 100. The integrated electrical fencing tape 100 is used in forming a fence system 200, which is discussed further below in FIG. 5.

The integrated electrical fencing tape 100 comprises substrate material 10 that may be made of vinyl, plastic, or another durable material. Preferably the durable material from which the fence is constructed is able to withstand exposure to the elements. In an embodiment, the substrate material 10 is formed as an elongated rectangular section.

Wires 20 are embedded within the substrate material 10 and enable electricity to flow through the wires 20. In an embodiment, the wires 20 are made from stainless steel. In an embodiment, the wires 20 are made from aluminium. In an embodiment, the wires 20 are made from copper. In an embodiment, the wires 20 are made from tinned copper wire. In an embodiment, the wires 20 are made from galvanized steel wire. In an embodiment, the wires 20 are made from nickel-plated wire. In an embodiment, the wires 20 are made from copper-clad steel wire. In an embodiment, the wires 20 are constructed of an electrically conductive medium.

The wires 20 are operably connected to a power source 43 (not shown in FIG. 1). The power source 43 can generate electricity and transmit it through the wires 20. The electricity transmitted through the wires 20 is preferably at a safe level so as not to potentially permanently harm people or humans that contact the wires 20.

In an embodiment, LED lights 30 are embedded in the substrate material 10. LED lights 30 may be structurally embedded into the substrate material 10. In an embodiment, the LED lights 30 may be embedded by adhering the LED lights 30 to the substrate material 10. In an embodiment, LED lights 30 are interwoven with the wires 20. In an embodiment, the LED lights 30 are placed on the substrate material 10. In an embodiment, the LED lights 30 run parallel to the wires 20.

In an embodiment, the LED lights 30 have a controller 35 operably attached thereto. The controller 35 is adapted to control the functioning of the LED lights 30 that is subject to various control situations. For example, the controller 35 permits the LED lights to be turned on and off at certain times and to light up in certain patters. The controller 35 can have predetermined programmed responses and/or be controlled by an exterior device that permits access to the programmable features of the controller 35.

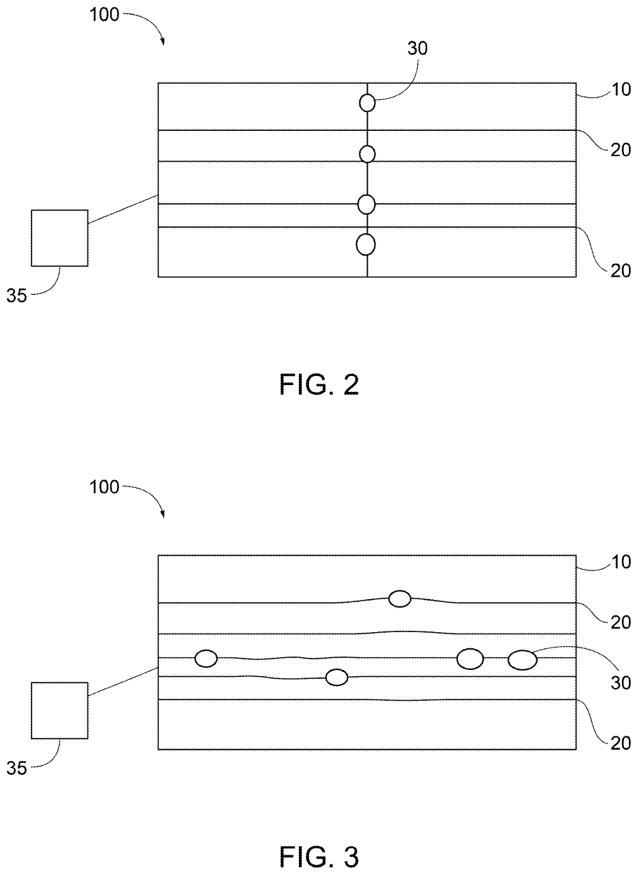

As shown in FIG. 2, in an embodiment, the LED lights 30 are orthogonally oriented with respect to the wires 20. In an embodiment, the LED lights 30 are equidistantly spaced with respect to each other. As shown in FIG. 3, in an embodiment, the LED lights 30 are non-equidistantly spaced with respect to each other.

In an embodiment, the LED lights and wires are twisted into a rope. In some embodiments, the LED lights and wires are braided together and form braids. 60a-60c of one or more electrical wires 20 and one or more strands of LED lights 30.

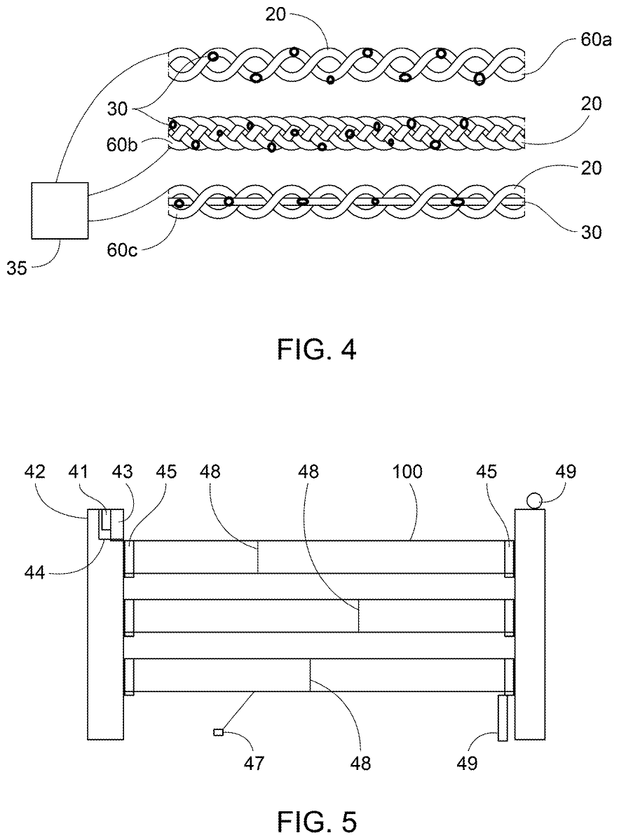

FIG. 4 shows diagrams of strands of LED lights 30 and electrical wires 20 formed into braids 60a-60c. The braids 60a-60c are formed from one or more electrical wires 20 and one or more strands of LED lights 30 and can be used to form components of a fence system.

Braid 60a is a two-strand braid formed of a strand of LED lights 30 and an electrical wire 20. Braid 60b is a three-strand braid formed of two strands of LED lights and one strand of electrical wire 20. Braid 60c is a three-strand braid formed of two strands of electrical wire 20 and one strand of LED lights 30. All braids 60a-60c may be operably connected to the controller 35.

In an embodiment, the braid is a two-strand twist braid. In an embodiment, the braid is a three-strand rope braid. In an embodiment, the braid is a four-strand twist braid. In an embodiment, the braid is a five-strand twist braid. When the LED lights and wires are braided together, when there is more than two braids, there may be more LED lights than electrical wires and vice versa. When there is an even number of rope braids of electrical wires and LED lights there may be equal numbers of rope braids and LED lights.

Turning to FIG. 5, shown is a diagram showing the fence system 200 using the integrated electrical fencing tape 100. In an embodiment, the LED lights 30 are activated automatically at dusk and turn off automatically at dawn. This can be achieved by including a light sensor 41 that detects ambient light levels and triggers the LED lights 30 accordingly. Alternatively, the LED lights 30 may be controlled manually using a switch or remote control.

The light sensor 41 may be placed on fence posts 42 located at various junctions where the integrated electrical fencing tape 100 is connected. The light sensor 41 is operably connected to a power source 43. The power source 43 may also be located at a fence post 42. The power source 43 and other electronic components may be kept with a housing 44. The light sensor 41 may be placed on the housing 44.

In an embodiment, the LED lights 30 may be activated when there is a failure in a portion of the fence system 200. For example, if a portion of the integrated electrical fencing tape 100 is damaged or malfunctioning, the LED lights 30 may operate in a certain manner to alert people as to the nature of the damage or malfunction, for example the lights may blink in a certain pattern, such as an SOS pattern, when a portion of the electrical integrated fencing tape 100 is broken. The functionality described herein can be implemented and/or programmed with the controller 35.

In an embodiment, the LED lights 30 may serve decorative purposes. In an embodiment, the LED lights 30 may be activated when there is a predetermined situation, such as too much activity in the fence or a condition that indicates an unwanted situation. In an embodiment, the LED lights 30 may be activated when there is need for repair. In an embodiment, the LED lights 30 may be activated when there is need for replacement. The functionality described herein can be implemented and/or programmed with the controller 35.

In an embodiment, the LED lights 30 forming the integrated electrical fencing tape 100 are positioned at regular intervals along the fence system 200. In an embodiment, the LED lights 30 forming the integrated electrical fencing tape 100 are positioned at irregular intervals along the fence. In an embodiment, the LED lights 30 forming the integrated electrical fencing tape 100 are positioned in areas that are most likely to fail. In an embodiment, the LED lights 30 forming the integrated electrical fencing tape 100 are positioned in areas that are most likely to contact with humans. In an embodiment, the LED lights 30 forming the integrated electrical fencing tape 100 are positioned in areas that are most likely to contact animals. In an embodiment the LED lights are interwoven with the wires forming the integrated electrical fencing tape 100.

In an embodiment, the LED lights 30 are powered by the same power source 43 that powers the electric charge that flows through the wires 20. In an embodiment, the LED lights 30 are powered by a separate power source than that which powers the electrical fencing tape, thereby enabling continued provision of status if the power source for the fence fails. In an embodiment, the LED lights are powered by solar power.

In should be understood that while LED light sources are mentioned, other light sources may be implemented instead.

The lighting sources allow the fence to be easily visible at night and in low-light conditions, improving safety for both the animals and humans who may encounter the fence.

The fence system 200 additionally can include end insulators 45 that are located at fence posts 42. The end insulators 45 are used to anchor the integrated electrical fencing tape 100 to sections of the fence system 200. Tensioners 46 are implemented to maintain the tension of the tape, ensuring it stays taut and effective. Anchors 47 are implemented to secure tape to the ground. Joiners 48 are used to connect pieces of tape together or to connect the tape to other components of the fence like wires or cables. Ground rods 49 can be implemented to provide a grounding system for the electric fence.

The LED lights used in the invention may be any suitable type of LED light, including but not limited to, standard white LED lights, colored LED lights, or flashing LED lights.

When implementing LED lights that are colored lights, the lights can be altered to reflect seasons, special occasions, moods, and holidays. For instance, the lights can be red and green during the Christmas season, green during St. Patrick's Day, orange during Halloween, and pink during Valentine's Day. The lights may be lit pink to reflect the birth or expected birth of a baby girl, or blue to reflect the birth or expected birth of a baby boy. The functionality described herein can be implemented and/or programmed with the controller 35. The LEDs lights can be programmed to respond in a certain manner based on a predetermined date.

As noted above, the LED lights can also provide an indication as to the status of the fence system. Additionally, the LED lights may provide an indication to others regarding the potential activity. For instance, the fence system 200 may have motion detector 49 that is able to detect when something is approaching. The motion detector 49 may send a signal to the LED lights 30 to activate the LED lights in a certain manner based on the signal received from the detector 39.

The electric fence system with integrated LED lighting provides several advantages over traditional electric fences. It improves safety by making the fence easily visible at night and in low-light conditions, reducing the risk of accidental contact. It provides a cost-effective lighting solution for rural areas where there may be limited access to electricity. It can be easily customized to meet the specific needs of different users by adjusting the positioning and type of LED lights used. It can provide indication of status of the electric fencing tape. Different scenarios involving the electric fence system can be determined and indicated by the LED lights. It should be understood, that in an embodiment, the LED lights may be the only feature of the fence system and that the function of the lights can be implemented without the accompanying functionality of the electric wire or the electric wire itself.

The electric fence system with integrated LED lighting provides a simple and effective solution to the problem of night-time visibility of electric fences. It is cost-effective, easy to install, and can be adapted to suit the needs of a wide range of users. The invention has potential applications in agriculture, ranching, and other industries where animal containment is required.

While embodiments of the present disclosure have been disclosed in exemplary forms, it will be apparent to those skilled in the art that many modifications, additions, and deletions can be made therein without departing from the spirit and scope of the invention and its equivalents, as set forth in the following claims.

What is claimed:

1. An electric fence system comprising:
at least one electrical wire adapted to transmit electricity;
a plurality of LEDs adapted to light in a predetermined manner; and
at least two fence posts, wherein the at least one electrical wire and the plurality of LEDs are adapted to be operably connected between the at least two fence posts.

2. The electric fence system of claim 1, wherein the at least one electrical wire and the plurality of LEDs form an integrated electrical fencing tape wherein the at least one electrical wire and the plurality of LEDs are operably connected to a substate material.

3. The electric fence system of claim 2, wherein each of the plurality of LEDs are non-equidistantly spaced on the substrate material.

4. The electric fence system of claim 1, wherein the plurality of LEDs and the at least one electrical wire are powered by one source of electricity.

5. The electric fence system of claim 1, further comprising a controller, wherein the controller is adapted to light the plurality of LEDs in response to a condition of the electric fence system.

6. The electric fence system of claim 1, wherein the at least one electrical wire is braided together with the plurality of LEDs.

7. The electric fence system of claim 1, wherein the plurality of LEDs is arranged as a strand of LEDs, wherein the strand of LEDs is arranged parallel with respect to the at least one electrical wire.

8. The electric fence system of claim 1, wherein the plurality of LEDs is arranged as a strand of LEDs, wherein the strand of LEDs is arranged orthogonally with respect to the at least one electrical wire.

9. The electric fence system of claim 1, further comprising a controller, wherein the controller is adapted to light the plurality of LEDs in response to a predetermined date.

10. The electric fence system of claim 1, wherein the plurality of LEDs flash when electrical power is no longer supplied to the electrical wire.

11. An integrated electrical fencing tape comprising:
a substrate material formed as an elongated rectangular section;
a plurality of electrical wires located along a length of the substrate material; and
a plurality of LEDs located on the substrate material along the length of the substrate material.

12. The integrated electrical fencing tape of claim 11, wherein the plurality of LEDs and the plurality of electrical wires are powered by one source of electricity.

13. The integrated electrical fencing tape of claim 11, further comprising a controller, wherein the controller is adapted to light the plurality of LEDs in response to a condition of an electric fence system the integrated electrical fencing tape forms a portion of.

14. The integrated electrical fencing tape of claim 11, wherein each of the plurality of LEDs are linearly non-equidistantly spaced on the substrate material.

15. The integrated electrical fencing tape of claim 11, wherein the plurality of LEDs is arranged as a strand of LEDs, wherein the strand of LEDs is arranged parallel with respect to the at least one electrical wire.

16. The integrated electrical fencing tape of claim 1, wherein the plurality of LEDs is arranged as a strand of LEDs, wherein the strand of LEDs is arranged orthogonally with respect to the at least one electrical wire.

17. The integrated electrical fencing tape of claim 1, further comprising a controller, wherein the controller is adapted to light the plurality of LEDs in response to a predetermined date.

18. The integrated electrical fencing tape of claim 11, wherein the plurality of LEDs flash when electrical power is no longer supplied to the electrical wire.

19. The integrated electrical fencing tape of claim 11, wherein at least some of the plurality of LEDs are powered by a solar power source.

20. A component for forming a fence comprising:
at least one electrical wire adapted to transmit electricity;
a plurality of LEDs operably connected to a controller and adapted to light in a predetermined manner; and
wherein the plurality of electrical wires is braided together with the plurality of LEDs.
